(19) United States
(12) Patent Application Publication
(10) Pub. No.: US 2023/0031560 A1
(43) Pub. Date: Feb. 2, 2023

(54) ROTATING MACHINE AND REFRIGERATION DEVICE USING SAME

(71) Applicant: Panasonic Intellectual Property Management Co., Ltd., Osaka-shi, Osaka (JP)

(72) Inventors: Hidetoshi TAGUCHI, Osaka (JP); Takumi HIKICHI, Osaka (JP); Masataka OZEKI, Osaka (JP)

(21) Appl. No.: 17/757,877

(22) PCT Filed: Dec. 7, 2020
(86) PCT No.: PCT/JP2020/045522

§ 371 Date: Jun. 22, 2022

(30) Foreign Application Priority Data
Dec. 23, 2019 (JP) 2019-231260

(51) Int. Cl. F25B 9/00; F01D 1/08; F01D 25/12; F25B 9/06

(52) U.S. Cl. CPC F25B 9/004; F01D 1/08; F01D 25/12; F25B 9/06

(57) ABSTRACT

A rotating machine (100) of the present disclosure includes: a bearing (10); a rotating shaft (20) having a hollow portion (21) included in a portion (20s) supported by the bearing (10); a fluid element (30) attached to one end portion of the rotating shaft (20); an introduction hole (22) that is provided, in the rotating shaft (20), on a back side of the fluid element (30), and that directs a working fluid to the hollow portion (21); and a discharge hole (23) that is provided, in the rotating shaft (20), at a position distant from the introduction hole (22) beyond the portion (20s) supported by the bearing (10), and that directs the working fluid to an outside of the hollow portion (21).

### TECHNICAL FIELD

The present disclosure relates to a rotating machine and a refrigeration device using the rotating machine.

### BACKGROUND ART

Patent Literature 1 discloses a cryogenic rotating machine. This cryogenic rotating machine includes: an impeller that imparts a kinetic energy to a cryogenic refrigerant that is a working fluid; a drive device that rotationally drives the impeller; a rotating shaft that transfers a rotational force of the drive device to the impeller; and a journal bearing that supports the rotating shaft. A heat-insulating material is disposed between the impeller and the journal bearing.

### CITATION LIST

### Patent Literature

Patent Literature 1: JP 2011-252442 A

### SUMMARY OF INVENTION

### Technical Problem

In a rotating machine, heat may be transferred from a heat generation source such as a bearing to a working fluid through a rotating shaft and a fluid element. When excessively receiving heat, the working fluid unintentionally increases in temperature.

The present disclosure provides a technique for reducing heat transferred from a heat generation source such as a bearing to a working fluid through a rotating shaft and a fluid element.

### Solution to Problem

A rotating machine according to the present disclosure includes:

a bearing;

a rotating shaft having a hollow portion included in a portion supported by the bearing;

a fluid element attached to one end portion of the rotating shaft;

an introduction hole that is provided, in the rotating shaft, on a back side of the fluid element, and that directs a working fluid to the hollow portion; and

a discharge hole that is provided, in the rotating shaft, at a position distant from the introduction hole beyond the portion supported by the bearing, and that directs the working fluid to an outside of the hollow portion.

### Advantageous Effects of Invention

According to the technique of the present disclosure, it is possible to reduce heat transferred from a heat generation source such as a bearing to a working fluid through a rotating shaft and a fluid element.

### BRIEF DESCRIPTION OF DRAWINGS

FIG. 1 is a cross-sectional view of a rotating machine according to Embodiment 1.

FIG. 2 is a partially enlarged cross-sectional view of the rotating machine shown in FIG. 1.

FIG. 3 is a cross-sectional view of a modification showing another shape of an annular recess.

FIG. 4 is a cross-sectional view of a rotating machine according to Embodiment 2.

FIG. 5 is a cross-sectional view of a rotating machine according to Embodiment 3.

FIG. 6 is a schematic diagram of a refrigeration device according to Embodiment 4.

### DESCRIPTION OF EMBODIMENTS

(Findings etc. on which the Present Disclosure is Based)

At the time when the inventors came to conceive of the present disclosure, as one problem of rotating machines that handle a cryogenic working fluid of −190° C. to −260° C. such as neon and helium, a large temperature difference between the working fluid and the machine part has been known. A large temperature difference between the working fluid and the machine part extremely increases the amount of heat flowing into the working fluid, changing the state quantity of the working fluid. Patent Literature 1 has proposed a structure for coping with this problem.

One of means for suppressing heat transfer from a heat generation source such as an electric motor and a bearing to a fluid element such as a turbine wheel is to increase the length of a rotating shaft for heat insulation. However, lengthening the rotating shaft changes the dynamic characteristics of the rotating shaft to impair the rotational stability, and thus makes it difficult to operate the rotating machine in a high rotational speed range. The inventors have found this problem and have come to constitute the subject matter of the present disclosure in order to solve this problem.

The present disclosure provides a technique for reducing heat transferred from a heat generation source such as a bearing to a working fluid through a rotating shaft and a fluid element while maintaining the rotational stability of the rotating shaft.

Hereinafter, embodiments will be described in detail with reference to the drawings. However, more detailed description than necessary may be omitted. For example, detailed description of a well-known matter or overlapping description of substantially the same structure may be omitted.

The accompanying drawings and the following description are provided for those skilled in the art to fully understand the present disclosure, and are not intended thereby to limit the subject matter recited in the claims.

### Embodiment 1

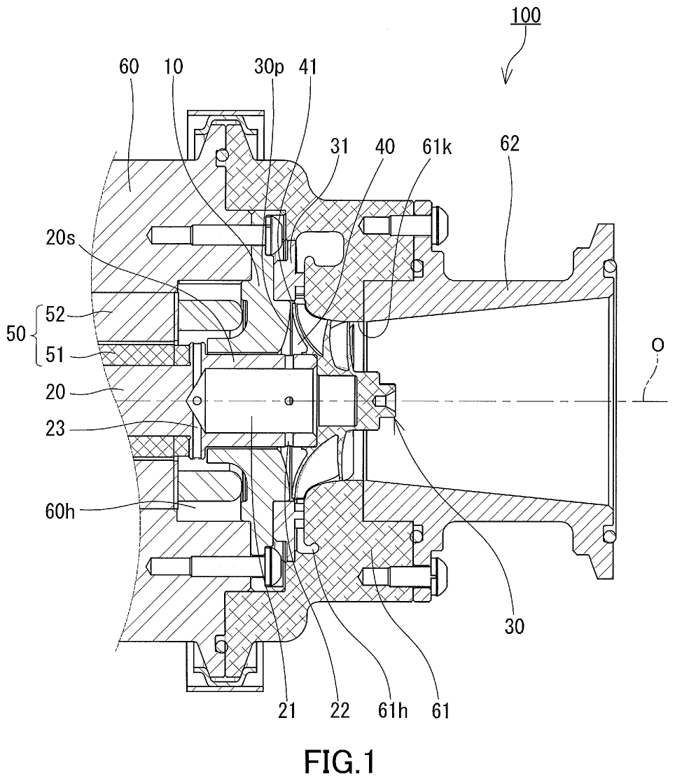

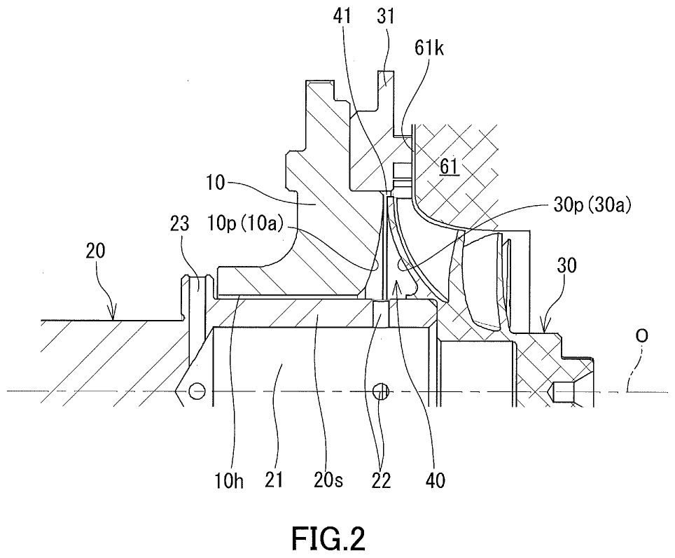

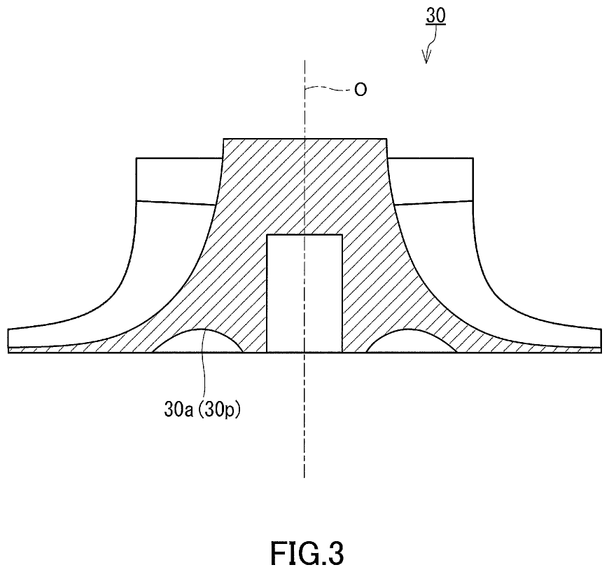

Hereinafter, Embodiment 1 will be described with reference to FIG. 1, FIG. 2, and FIG. 3.

[1-1. Configuration]

FIG. 1 is a cross-sectional view of a rotating machine 100 according to the present embodiment. FIG. 2 is a partially enlarged cross-sectional view of the rotating machine 100 shown in FIG. 1. As shown in FIG. 1 and FIG. 2, the rotating machine 100 includes a bearing 10, a rotating shaft 20, and a turbine wheel 30. In the present embodiment, the rotating machine 100 is an expander. Specifically, the rotating machine 100 is a radial turbine.

The bearing 10 supports the rotating shaft 20. In the present embodiment, the bearing 10 is a plain bearing. A working fluid for the rotating machine 100 is used as a lubricant for the bearing 10.

The turbine wheel 30 is a fluid element attached to one end portion of the rotating shaft 20. The turbine wheel 30 rotates together with the rotating shaft 20. Work is extracted from the working fluid by the turbine wheel 30. According to the technique of the present disclosure, the temperature of the turbine wheel 30 can be decreased. Accordingly, it is possible to reduce the amount of heat the working fluid receives from the turbine wheel 30 when passing through the turbine wheel 30.

The rotating shaft 20 has a hollow portion 21, at least one introduction hole 22, and at least one first discharge hole 23. The hollow portion 21 is a space inside the rotating shaft 20. The hollow portion 21 is included in a portion 20s supported by the bearing 10. The introduction hole 22 is provided, in the rotating shaft 20, on the back side of the turbine wheel 30. The first discharge hole 23 is provided, in the rotating shaft 20, at a position distant from the introduction hole 22 beyond the portion 20s supported by the bearing 10. The introduction hole 22 serves to direct the working fluid from the outside of the rotating shaft 20 to the hollow portion 21. The first discharge hole 23 serves to direct the working fluid from the hollow portion 21 to the outside of the rotating shaft 20.

The working fluid is introduced into the hollow portion 21 through the introduction hole 22, flows in the hollow portion 21 in a direction parallel to an axis O of the rotating shaft 20, and is discharged from the hollow portion 21 through the first discharge hole 23. At this time, the rotating shaft 20 is cooled by the working fluid, and accordingly the temperatures of the rotating shaft 20 and the turbine wheel 30 decrease. Accordingly, it is possible to suppress heat transfer from the bearing 10 to the working fluid through the rotating shaft 20 and the turbine wheel 30. As a result, an unintended increase in temperature of the working fluid can be suppressed. Increasing the length of the rotating shaft 20 for suppressing heat transfer is not essential, and accordingly the rotational stability of the rotating shaft 20 is also maintained.

In the present embodiment, the length of the hollow portion 21 in the axial direction exceeds the length of the portion 20s supported by the bearing 10. In the axial direction, the distance between the introduction hole 22 and the first discharge hole 23 is longer than the portion 20s supported by the bearing 10. In the axial direction, the entire portion 20s supported by the bearing 10 fits in a zone in which the hollow portion 21 is provided. According to such a structure, the supported portion 20s is entirely cooled, and accordingly the effect described above is more sufficiently obtained. As long as the strength of the rotating shaft 20 is sufficiently maintained, the inner diameter of the hollow portion 21 is not particularly limited. The inner diameter of the hollow portion 21 may be constant in the axial direction, or may vary in the axial direction.

In the present description, the “axial direction” is the direction parallel to the axis O of the rotating shaft 20.

In the present embodiment, a plurality of introduction holes 22 are provided at equal angular intervals in the circumferential direction of the rotating shaft 20. For example, four introduction holes 22 are provided at angular intervals of 90 degrees. The positions of the plurality of introduction holes 22 in the axial direction coincide with each other. Such a structure facilitates smooth introduction of the working fluid into the hollow portion 21. Only one introduction hole 22 may be provided.

In the present embodiment, a plurality of first discharge holes 23 are provided at equal angular intervals in the circumferential direction of the rotating shaft. For example, four first discharge holes 23 are provided at angular intervals of 90 degrees. The positions of the plurality of first discharge holes 23 in the axial direction coincide with each other. Such a structure facilitates smooth discharge of the working fluid from the hollow portion 21. Only one first discharge hole 23 may be provided.

The introduction holes 22 and the first discharge holes 23 each open toward the radial direction of the rotating shaft 20. That is, the introduction holes 22 and the first discharge holes 23 are provided not in both end surfaces of the rotating shaft 20 in the axial direction but in a cylindrical surface of the rotating shaft 20. Such a structure facilitates smooth introduction of the working fluid into the hollow portion 21, and facilitates smooth discharge of the working fluid from the hollow portion 21. Furthermore, according to such a structure, the distance between the introduction hole 22 and the first discharge hole 23 can be shortened as much as possible. It is possible to suppress, to the minimum, the pressure loss at the time when the working fluid is introduced into the hollow portion 21 and the pressure loss at the time when the working fluid is discharged from the hollow portion 21. Accordingly, even in the case where the difference between the pressure of the working fluid in the introduction hole 22 and the pressure of the working fluid in the first discharge hole 23 is small, the working fluid can be smoothly introduced into the hollow portion 21. Even in the case where the rotating machine 100 is operated under conditions of a low pressure and a low flow rate, an increase in temperature of the working fluid can be suppressed.

In the axial direction, no other part exists between the bearing 10 and the turbine wheel 30. In the axial direction, the turbine wheel 30 is disposed slightly distant from the bearing 10 so as not to be in direct contact with the bearing 10. A back surface 30p of the turbine wheel 30 faces an end surface 10p of the bearing 10. A back space 40 exists between the bearing 10 and the turbine wheel 30. The back space 40 is an annular space. The back space 40 communicates with the flow path of the working fluid, and accordingly allows the working fluid to enter the back space 40. The introduction hole 22 allows communication between the back space 40 and the hollow portion 21 of the rotating shaft 20. Such a structure facilitates smooth introduction of the working fluid into the hollow portion 21 through the introduction hole 22.

In the present description, “the back surface 30p of the turbine wheel 30” is a surface on the side facing the bearing 10.

The rotating machine 100 further includes a turbine nozzle 31, a bearing housing 60, and a turbine housing 61. The bearing housing 60 and the turbine housing 61 are a first housing and a second housing, respectively. The bearing 10 is fixed to an end surface of the bearing housing 60. The turbine housing 61 is fixed to the bearing housing 60 so as to cover the bearing 10 and the turbine wheel 30. The turbine housing 61 has a volute 61h that is a flow path of the working fluid. The volute 61h communicates with a suction port (not shown) of the rotating machine 100. The turbine nozzle 31 is disposed between the bearing 10 and the turbine housing 61. The turbine nozzle 31 serves to direct the working fluid toward the turbine wheel 30. The turbine nozzle 31 has an annular shape and surrounds the turbine wheel 30. A stationary inner wall surface 61k of the turbine housing 61 faces each of the turbine wheel 30 and the turbine nozzle 31. This defines flow paths of the working fluid. Specifically, a flow path of the working fluid is formed between the turbine housing 61 and the turbine nozzle 31. A flow path of the working fluid is formed between the turbine housing 61 and the turbine wheel 30.

A gap 41 exists between the turbine wheel 30 and the turbine nozzle 31. Specifically, the gap 41 exists between the outer circumferential end surface of the turbine wheel 30 and the inner circumferential end surface of the turbine nozzle 31 in the radial direction of the rotating shaft 20. The gap 41 leads to the flow path of the working fluid and the introduction hole 22. The working fluid can flow into the introduction hole 22 through the turbine nozzle 31 and the gap 41. Specifically, the gap 41 leads to the back space 40. The working fluid can flow into the introduction hole 22 through the turbine nozzle 31, the gap 41, and the back space 40.

As shown in FIG. 2, the back space 40 includes a portion increasing in dimension in the axial direction of the rotating shaft 20 from the outer circumferential end surface of the turbine wheel 30 in the radial direction of the rotating shaft 20 toward an outer circumferential surface of the rotating shaft 20. In the present embodiment, the size of the back space 40 in the axial direction of the rotating shaft 20 increases from the gap 41 toward the introduction hole 22. According to such a structure, when passing through the gap 41, the working fluid increases in velocity and accordingly increases in pressure in the back space 40. This facilitates smooth introduction of the working fluid into the hollow portion 21 through the introduction hole 22.

In the present embodiment, the turbine wheel 30 has, on the back side, an annular recess 30a forming a portion of the back space 40. According to such a structure, even if the bearing 10 and the turbine wheel 30 are sufficiently brought close to each other, the back space 40 that is sufficiently large can be left. Lengthening the rotating shaft 20 for leaving the back space 40 can also be avoided. The shape of the annular recess 30a is not particularly limited.

FIG. 3 is a cross-sectional view of the turbine wheel 30 showing another shape of the annular recess 30a. As shown in FIG. 3, in a longitudinal cross section of the turbine wheel 30, the annular recess 30a may have a semicircular or semielliptical shape. The “longitudinal cross section” is a cross section parallel to the axis O and including the axis O.

In the present embodiment, the bearing 10 has, in the end surface 10p adjacent to the turbine wheel 30, an annular recess 10a that is depressed toward a bearing hole 10h. The end surface 10p faces the turbine wheel 30. The annular recess 10a of the bearing 10 forms a portion of the back space 40. In other words, the end surface 10p of the bearing 10 is inclined with respect to the radial direction of the rotating shaft 20. According to such a structure, even if the bearing 10 and the turbine wheel 30 are sufficiently brought close to each other, the back space 40 that is sufficiently large can be left. Lengthening the rotating shaft 20 for leaving the back space 40 can also be avoided. The profile of the end surface 10p in the longitudinal cross section of the rotating machine 100 may be a straight line or a curved surface.

Additionally, the annular recess 30a of the turbine wheel 30 and/or the annular recess 10a of the bearing 10 does not need to be provided. In other words, the back surface 30p of the turbine wheel 30 may be a surface perpendicular to the axis O. The end surface 10p of the bearing 10 may be a surface perpendicular to the axis O. As long as the introduction hole 22 overlaps the gap between the bearing 10 and the turbine wheel 30 in the axial direction and the introduction hole 22 opens toward the gap, the working fluid can flow into the introduction hole 22.

The rotating machine 100 further includes a turbine diffuser 62. The turbine diffuser 62 is a tubular part and is disposed downstream of the turbine wheel 30. The turbine diffuser 62 is attached to the turbine housing 61 so as to open toward the turbine wheel 30. The turbine wheel 30 and the turbine diffuser 62 are positioned so as to be coaxial with each other. The inner diameter of the turbine diffuser 62 gradually increases along the axial direction.

The rotating machine 100 further includes an electric motor 50. The electric motor 50 serves to rotate the rotating shaft 20. The electric motor 50 is housed in a space 60h inside the bearing housing 60. The electric motor 50 includes a rotor 51 and a stator 52. The rotor 51 is fixed to the rotating shaft 20. The stator 52 is fixed to the bearing housing 60. In the present embodiment, the electric motor 50 is of the inner rotor type. The electric motor 50 may be used as an electric generator.

According to the present embodiment, the electric motor 50, the bearing 10, and the turbine wheel 30 are arranged in this order in the axial direction. According to such an arrangement, the heat transfer direction and the flow direction of the working fluid in the hollow portion 21 are opposite to each other. As a result, it is possible to efficiently cool the bearing 10 and thus the electric motor 50. It is possible to effectively suppress heat transfer from the bearing 10 and the electric motor 50 to the working fluid.

In the present embodiment, the first discharge hole 23 allows communication between the space 60h in which the electric motor 50 is housed and the hollow portion 21 of the rotating shaft 20. The space 60h in which the electric motor 50 is housed is the space 60h inside the bearing housing 60. According to such a structure, not only the bearing 10 but also the electric motor 50 can be cooled by the working fluid. The electric motor 50 generates heat due to copper loss and iron loss. By cooling the electric motor 50 by the working fluid, the heat transferred from the electric motor 50 to the turbine wheel 30 through the rotating shaft 20 can be further reduced. As a result, an unintended increase in temperature of the working fluid can be further suppressed. By cooling the electric motor 50, the efficiency of the electric motor 50 also can improve, thereby reducing power consumption.

The space 60h communicates with the outside of the rotating machine 100 through an exhaust passage which is not shown. The exhaust passage may be a passage for drawing out a wire connected to the electric motor 50 to the outside. By using the passage for drawing out the wire to the outside also as the exhaust passage, the structure of parts such as the bearing housing 60 can be simplified. However, the exhaust passage may be a passage dedicated for discharging the working fluid to the outside of the rotating machine 100.

[1-2. Operation]

Next, an example of an operation of the rotating machine 100 will be described.

The working fluid flows into the volute 61h from a suction port (not shown) provided in the turbine housing 61, and further flows into the turbine nozzle 31 from the outer circumference of the turbine nozzle 31. The working fluid expands in the turbine nozzle 31, and accordingly its pressure is converted into the flow velocity. Thereafter, the working fluid is blown against the turbine wheel 30. An impulse is applied to the turbine wheel 30 by the blown working fluid. Depending on the state of the working fluid, the pressure is converted into the flow velocity again when the working fluid is discharged from the turbine wheel 30, so that the turbine wheel 30 receives a reaction from the working fluid. The rotating shaft 20 rotates by the impulse and reaction, and thus work is extracted from the working fluid. The working fluid discharged from the turbine wheel 30 flows into the turbine diffuser 62. The working fluid decelerates while flowing in the axial direction of the turbine diffuser 62 so as to be away from the turbine wheel 30, recovering its pressure. Thereafter, the working fluid is discharged to the outside of the rotating machine 100.

The above operation continuously decreases the temperature and pressure of the working fluid. For example, in an expansion turbine having a pressure ratio of approximately 2 to 3, in the case where the temperature of the working fluid in the turbine nozzle 31 is 20° C., the temperature of the working fluid at an outlet of the turbine diffuser 62 reaches approximately −20° C. to −40° C. The working fluid expands and thus decreases in temperature. This tends to cause a large temperature difference between the temperature of each of the parts and the temperature of the working fluid, from the turbine nozzle 31 to the turbine wheel 30.

When the working fluid passes through the turbine nozzle 31 and the turbine wheel 30, a portion of the working fluid is directed to the back space 40 through the gap 41, which exists at the boundary between the turbine wheel 30 and the turbine nozzle 31. The working fluid flows into the hollow portion 21 through the introduction hole 22, flows through the hollow portion 21, and is discharged to the outside of the rotating shaft 20 through the first discharge hole 23. At this time, the rotating shaft 20 is cooled by the working fluid, and accordingly the temperatures of the rotating shaft 20 and the turbine wheel 30 decrease. Heat transfer from the bearing 10 to the working fluid through the rotating shaft 20 and the turbine wheel 30 can be suppressed. As a result, an unintended increase in temperature of the working fluid can be suppressed. Increasing the length of the rotating shaft 20 for suppressing heat transfer is not essential, and accordingly the rotational stability of the rotating shaft 20 is also maintained.

The flow rate of the working fluid led to the back space 40 depends on: (i) the dimensions of the gap 41; and (ii) the difference between the pressure of the working fluid at an entrance of the gap 41 and the pressure of the working fluid at an exit of the first discharge hole 23. In order to obtain a desired effect, the working fluid having the flow rate of 1 to 10% of the total flow rate is introduced into the hollow portion 21 through the gap 41, the back space 40 and the introduction hole 22. During the rotation of the rotating shaft 20, an extremely large pressure is generated in a bearing gap between the bearing 10 and the rotating shaft 20. Accordingly, the working fluid hardly flows into the bearing gap.

[1-3. Effects etc.]

As described above, in the present embodiment, the rotating machine 100 is configured to cause the working fluid to flow through the hollow portion 21 of the rotating shaft 20. Accordingly, heat transfer from the bearing 10 to the working fluid through the rotating shaft 20 and the fluid element can be suppressed. As a result, an unintended increase in temperature of the working fluid can be suppressed. Increasing the length of the rotating shaft 20 for suppressing heat transfer is not essential, and accordingly the rotational stability of the rotating shaft 20 is also maintained.

Furthermore, in the present embodiment, the introduction hole 22 and the discharge hole 23 each may open toward the radial direction of the rotating shaft 20. Such a structure facilitates smooth introduction of the working fluid into the hollow portion 21, and facilitates smooth discharge of the working fluid from the hollow portion 21.

Furthermore, in the present embodiment, the rotating machine 100 may further include the back space 40 that exists between the bearing 10 and the fluid element in the axial direction of the rotating shaft 20 and that allows the working fluid to enter the back space 40. The introduction hole 22 may allow communication between the back space 40 and the hollow portion 21 of the rotating shaft 20. Such a structure facilitates smooth introduction of the working fluid into the hollow portion 21 through the introduction hole 22.

Furthermore, in the present embodiment, the back space 40 may include a portion increasing in dimension in the axial direction of the rotating shaft 20 from the outer circumferential end surface of the fluid element in the radial direction of the rotating shaft 20 toward the outer circumferential surface of the rotating shaft 20. Such a structure facilitates smooth introduction of the working fluid into the hollow portion 21 through the introduction hole 22.

Furthermore, in the present embodiment, the fluid element may have, on the back side, the annular recess 30a forming a portion of the back space 40. According to such a structure, even if the bearing 10 and the fluid element are sufficiently brought close to each other, the back space 40 that is sufficiently large can be left.

Furthermore, in the present embodiment, the bearing 10 may have, on the end surface 10p adjacent to the fluid element, the annular recess 10a that is depressed toward the bearing hole 10h. The annular recess 10a of the bearing 10 may form a portion of the back space 40. According to such a structure, even if the bearing 10 and the fluid element are sufficiently brought close to each other, the back space 40 that is sufficiently large can be left.

Furthermore, in the present embodiment, the rotating machine 100 may further include the electric motor 50 that rotates the rotating shaft 20. The electric motor 50, the bearing 10, and the fluid element may be arranged in this order in the axial direction of the rotating shaft 20. According to such an arrangement, the heat transfer direction and the flow direction of the working fluid in the hollow portion 21 are opposite to each other. As a result, it is possible to efficiently cool the bearing 10 and thus the electric motor 50.

Furthermore, in the present embodiment, the rotating machine 100 may further include the electric motor 50 that rotates the rotating shaft 20. The discharge hole 23 may allow communication between the space 60h in which the electric motor 50 is housed and the hollow portion 21 of the rotating shaft 20. According to such a structure, not only the bearing 10 but also the electric motor 50 can be cooled by the working fluid.

Furthermore, in the present embodiment, the fluid element may be the turbine wheel 30. According to the technique of the present disclosure, it is possible to reduce the amount of heat the working fluid receives from the turbine wheel 30 when passing through the turbine wheel 30.

Furthermore, in the present embodiment, the rotating machine 100 may further include the turbine nozzle 31 that directs the working fluid toward the turbine wheel 30, and the gap 41 that exists between the turbine nozzle 31 and the turbine wheel 30, and that leads to the introduction hole 22. According to such a structure, the working fluid can flow into the introduction hole 22 through the turbine nozzle 31 and the gap 41.

### Embodiment 2

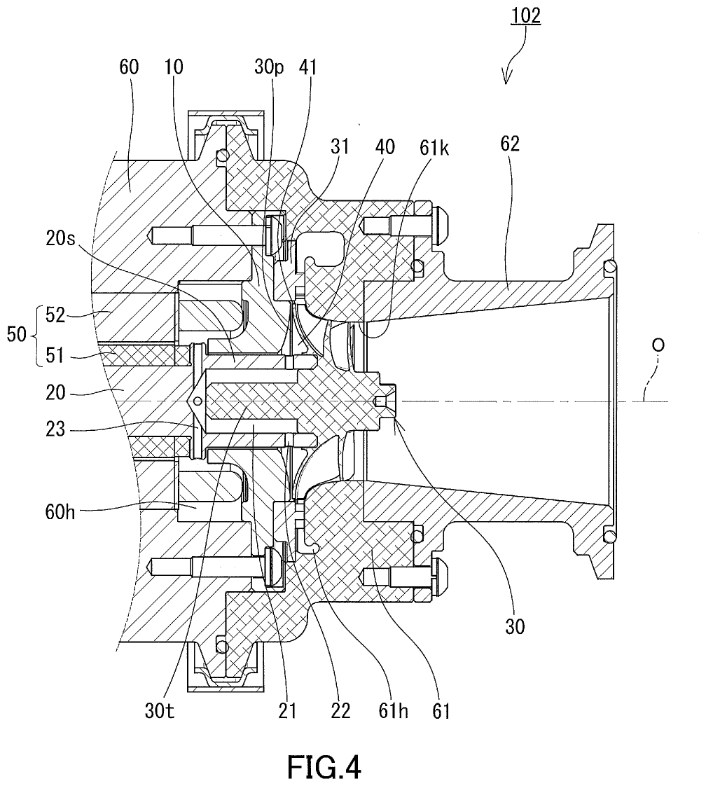

Hereinafter, Embodiment 2 will be described with reference to FIG. 4.

[2-1. Configuration]

FIG. 4 is a cross-sectional view of a rotating machine 102 according to Embodiment 2. The rotating machine 102 of the present embodiment has the same structure as the rotating machine 100 of Embodiment 1 except for a core 30t. The same components as those of Embodiment 1 are denoted by the same reference numerals, and detailed description thereof will be omitted.

The rotating machine 102 further includes the core 30t disposed in the hollow portion 21. The core 30t has a smaller diameter than the inner diameter of the hollow portion 21. Such a structure increases the flow velocity of the working fluid introduced into the hollow portion 21, increasing the heat transfer coefficient between the inner wall surface of the hollow portion 21 and the working fluid. Accordingly, it is possible to further decrease the temperatures of the rotating shaft 20 and the turbine wheel 30. It is possible to reduce the flow rate of the working fluid in the hollow portion 21.

In the present embodiment, the core 30t is a portion of the turbine wheel 30. The core 30t has a cylindrical shape extending in the axial direction from the hub of the turbine wheel 30. In a transverse cross section of the rotating shaft 20, a space around the core 30t has an annular shape. The “transverse cross section” is a cross section perpendicular to the axis O. The working fluid flows from the introduction hole 22 toward the first discharge hole 23 while swirling around the core 30t. The core 30t and the rotating shaft 20 are positioned so as to be coaxial with each other. The length of the core 30t is approximately equal to the length from the introduction hole 22 to the first discharge hole 23 in the axial direction.

Additionally, it is not essential that the core 30t is integrally formed with the turbine wheel 30. The core 30t and the turbine wheel 30 may be separate parts. Furthermore, the core 30t may be a portion integrally formed with the rotating shaft 20.

[2-2. Effects etc.]

In the present embodiment, the rotating machine 200 may further include the core 30t disposed in the hollow portion 21 and having a smaller diameter than the inner diameter of the hollow portion 21. According to such a structure, it is possible to further decrease the temperatures of the rotating shaft 20 and the fluid element.

### Embodiment 3

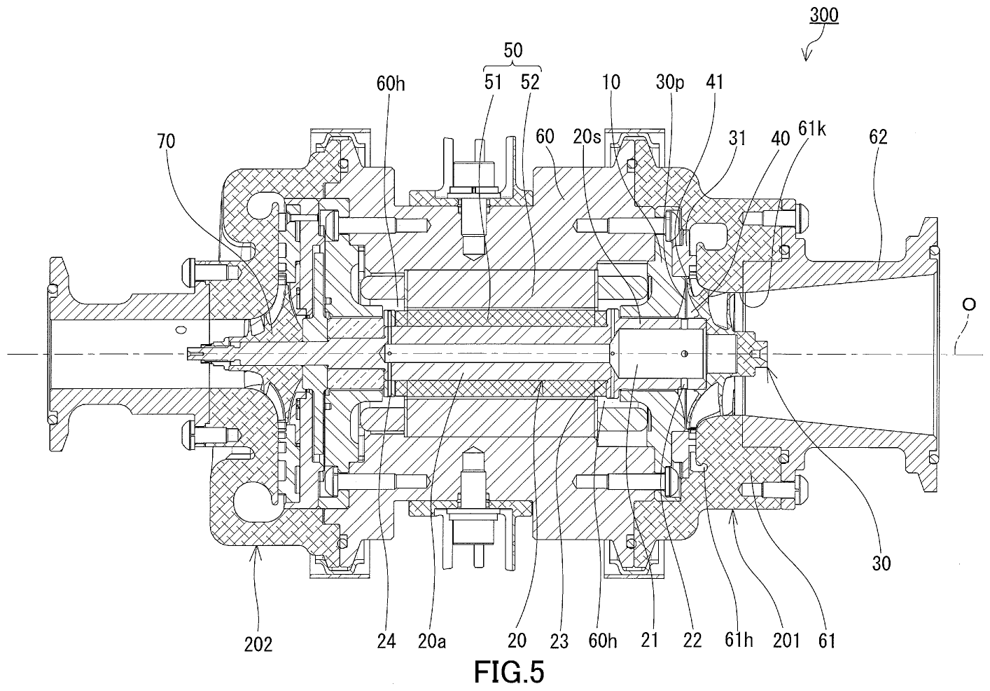

Hereinafter, Embodiment 3 will be described with reference to FIG. 5.

[3-1. Configuration]

FIG. 5 is a cross-sectional view of a rotating machine 300 according to Embodiment 3. The rotating machine 300 of the present embodiment further includes the following in addition to the structure of the rotating machine 100 of Embodiment 1.

The rotating machine 300 further includes a second discharge hole 24. The second discharge hole 24 is provided in the rotating shaft 20. The electric motor 50 is positioned between the first discharge hole 23 and the second discharge hole 24 in the axial direction of the rotating shaft 20. In the present embodiment, the rotor 51 of the electric motor 50 is positioned between the first discharge hole 23 and the second discharge hole 24 in the axial direction of the rotating shaft 20. The bearing 10 and the electric motor 50 are positioned between the introduction hole 22 and the second discharge hole 24 in the axial direction of the rotating shaft 20. The second discharge hole 24 serves to direct the working fluid from the hollow portion 21 to the outside of the rotating shaft 20. The rotating shaft 20 has a portion 20a into which the rotor 51 of the electric motor 50 is fitted. The hollow portion 21 extends from the introduction hole 22 to the second discharge hole 24 beyond the fitted portion 20a in the axial direction.

According to the present embodiment, a portion of the working fluid is discharged from the hollow portion 21 through the first discharge hole 23, and the remainder of the working fluid is discharged from the hollow portion 21 through the second discharge hole 24. The second discharge hole 24 can cool the portion 20a into which the rotor 51 is fitted and the rotor 51 of the electric motor 50. Accordingly, it is possible to more effectively suppress heat transfer from the bearing 10 to the working fluid through the rotating shaft 20 and the turbine wheel 30. An unintended increase in temperature of the working fluid can be further suppressed. By cooling the electric motor 50, the efficiency of the electric motor 50 also can improve, thereby reducing power consumption.

In the present embodiment, the outside of the rotating shaft 20 includes the space 60h in which the electric motor 50 is housed. The second discharge hole 24 allows communication between the space 60h in which the electric motor 50 is housed and the hollow portion 21 of the rotating shaft 20. The space 60h in which the electric motor 50 is housed is the space 60h inside the bearing housing 60. According to such a structure, it is possible to more effectively cool the electric motor 50.

In the present embodiment, a plurality of second discharge holes 24 are provided at equal angular intervals in the circumferential direction of the rotating shaft. For example, four second discharge holes 24 are provided at angular intervals of 90 degrees. The positions of the plurality of second discharge holes 24 in the axial direction coincide with each other. Such a structure facilitates smooth discharge of the working fluid from the hollow portion 21. Only one second discharge hole 24 may be provided.

The second discharge holes 24 open toward the radial direction of the rotating shaft 20. That is, the second discharge holes 24 are provided not in the end surface of the rotating shaft 20 in the axial direction but in the cylindrical surface of the rotating shaft 20. Such a structure facilitates smooth discharge of the working fluid from the hollow portion 21.

In the present embodiment, the rotating machine 300 includes an expansion mechanism 201 and a compression mechanism 202. The expansion mechanism 201 is a portion corresponding to the rotating machine 100 described with reference to Embodiment 1. The compression mechanism 202 includes an impeller 70. The impeller 70 is a part for compressing the working fluid, and is a second fluid element attached to the other end portion of the rotating shaft 20. The rotating machine 300 is a so-called expander-integrated compressor. The expansion energy of the working fluid recovered by the expansion mechanism 201 is used as a portion of work for compressing the working fluid in the compression mechanism 202.

Additionally, by increasing the inner diameter of the hollow portion 21 and the opening diameter of the second discharge hole 24 within the design tolerance limit of the rotating shaft 20, it is possible to sufficiently maintain the flow rate of the working fluid in the hollow portion 21 to obtain a desired effect even if the first discharge hole 23 is omitted. The second discharge hole 24 may be provided instead of the first discharge hole 23.

[3-2. Effects etc.]

In the present embodiment, the rotating machine 300 may further include the second discharge hole 24 provided in the rotating shaft 20 when the discharge hole 23 is defined as the first discharge hole 23. The electric motor 50 may be positioned between the first discharge hole 23 and the second discharge hole 24 in the axial direction of the rotating shaft 20. According to such a structure, it is possible to more effectively suppress heat transfer from the bearing 10 to the working fluid through the rotating shaft 20 and the fluid element. An unintended increase in temperature of the working fluid can be further suppressed. By cooling the electric motor 50, the efficiency of the electric motor 50 also can improve, thereby reducing power consumption.

In the present embodiment, the second discharge hole 24 may allow communication between the space 60h in which the electric motor 50 is housed and the hollow portion 21 of the rotating shaft 20. According to such a structure, it is possible to more effectively cool the electric motor 50.

### Embodiment 4

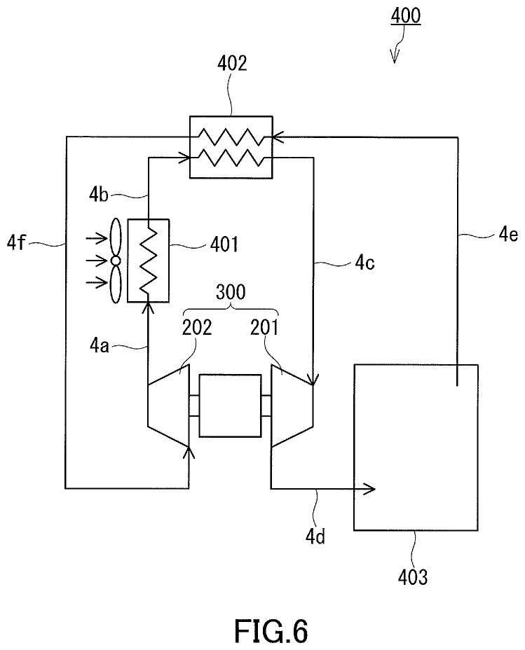

Hereinafter, Embodiment 4 will be described with reference to FIG. 6.

[4-1. Structure]

FIG. 6 is a schematic diagram of a refrigeration device 400 according to Embodiment 4. The refrigeration device 400 includes the rotating machine 300, a first heat exchanger 401, and a second heat exchanger 402.

The rotating machine 300 has the expansion mechanism 201 and the compression mechanism 202. The rotating machine 300 is the rotating machine described in Embodiment 3.

The first heat exchanger 401 serves to cool the refrigerant by other fluid. The other fluid may be a gas or a liquid. The second heat exchanger 402 is an internal heat exchanger for recovering cold of the refrigerant. Examples of the first heat exchanger 401 and the second heat exchanger 402 include a fin tube heat exchanger, a plate heat exchanger, a double-tube heat exchanger, and a shell-and-tube heat exchanger.

The thermal cycle of the refrigeration device 400 is an air refrigeration cycle in which air is used as the refrigerant. A low-temperature air generated by the refrigeration device 400 is directed to a target space 403. The target space 403 is, for example, a freezer. The refrigeration device 400 may be used for cabin air conditioning in aircraft. Since the global warming potential (GWP) of air is zero, it is desirable to use air as the refrigerant from the viewpoint of global environment protection. Furthermore, by using air as the refrigerant, the refrigeration device 400 can be constituted as an open system. That is, it is permitted to release air discharged from the hollow portion 21 of the rotating shaft 20 into the atmosphere without recovering the air.

The rotating machine 300, the first heat exchanger 401, and the second heat exchanger 402 are connected to each other by flow paths 4a to 4f. The flow path 4a connects a discharge port of the compression mechanism 202 and a refrigerant inlet of the first heat exchanger 401. The flow path 4b connects a refrigerant outlet of the first heat exchanger 401 and a high-pressure side inlet of the second heat exchanger 402. The flow path 4c connects a high-pressure side outlet of the second heat exchanger 402 and a suction port of the expansion mechanism 201. The flow path 4d connects a discharge port of the expansion mechanism 201 and the target space 403. The flow path 4e connects the target space 403 and a low-pressure side inlet of the second heat exchanger 402. The flow path 4f connects a low-pressure side outlet of the second heat exchanger 402 and a suction port of the compression mechanism 202. In the flow paths 4a to 4f, other equipment may be disposed, such as another heat exchanger and a defroster.

The refrigerant compressed in the compression mechanism 202 is cooled in the first heat exchanger 401 and the second heat exchanger 402. The cooled refrigerant expands in the expansion mechanism 201. This further decreases the temperature of the refrigerant. The low-temperature refrigerant is supplied to the target space 403 for use for a desired purpose. The refrigerant discharged from the target space 403 is heated in the second heat exchanger 402, and then is introduced into the compression mechanism 202. In an example, the temperature of the refrigerant at the suction port of the compression mechanism 202 is 20° C. The temperature of the refrigerant at the discharge port of the compression mechanism 202 is 85° C. The temperature of the refrigerant at the refrigerant outlet of the first heat exchanger 401 is 40° C. The temperature of the refrigerant at the suction port of the expansion mechanism 201 is −30° C. The temperature of the refrigerant at the discharge port of the expansion mechanism 201 is −70° C.

[4-2. Effects etc.]

The refrigeration device 400 of the present embodiment includes the rotating machine 300. By adopting the rotating machine 300, a lower-temperature refrigerant can be generated.

In the present embodiment, the refrigerant may be air. It is desirable to use air as the refrigerant from the viewpoint of global environment protection. Furthermore, by using air as the refrigerant, the refrigeration device 400 can be constituted as an open system.

According to the refrigeration device 400 of the present embodiment, heat transfer from the parts of the expansion mechanism 201 to the refrigerant is suppressed in the rotating machine 300, and accordingly a lower-temperature refrigerant can be generated. Adopting the rotating machine 300 improves the coefficient of performance of the refrigeration device 400.

### Other Embodiments

As described above, Embodiments 1 to 4 have been described as an illustration of the technique disclosed in the present application. However, the technique according to the present disclosure is not limited these, and can be applied to embodiments obtained by making modifications, replacements, additions, omissions, and the like. Furthermore, the components described in Embodiments 1 to 4 above can be combined to obtain a new embodiment.

The technique of the present disclosure is applicable not only to expansion turbines but also to centrifugal compressors. In centrifugal compressors as well, the working fluid can enter a back space of an impeller through a gap that exists between the impeller and a diffuser in the radial direction of a rotating shaft. Accordingly, the technique of the present disclosure is applicable.

### INDUSTRIAL APPLICABILITY

The technique of the present disclosure is applicable to rotating machines such as compressors, expansion turbines, and exhaust gas turbine superchargers.

1. A rotating machine comprising:
a bearing;
a rotating shaft having a hollow portion included in a portion supported by the bearing;
a fluid element attached to one end portion of the rotating shaft;
an introduction hole that is provided, in the rotating shaft, on a back side of the fluid element, and that directs a working fluid to the hollow portion; and
a discharge hole that is provided, in the rotating shaft, at a position distant from the introduction hole beyond the portion supported by the bearing, and that directs the working fluid to an outside of the hollow portion.

2. The rotating machine according to claim 1, wherein
the introduction hole and the discharge hole each open toward a radial direction of the rotating shaft.

3. The rotating machine according to claim 1, further comprising
a back space that exists between the bearing and the fluid element in an axial direction of the rotating shaft, and that allows the working fluid to enter the back space, wherein
the introduction hole allows communication between the back space and the hollow portion of the rotating shaft.

4. The rotating machine according to claim 3, wherein
the back space comprises a portion increasing in dimension in the axial direction of the rotating shaft from an outer circumferential end surface of the fluid element in a radial direction of the rotating shaft toward an outer circumferential surface of the rotating shaft.

5. The rotating machine according to claim 3, wherein
the fluid element comprises, on the back side, an annular recess forming a portion of the back space.

6. The rotating machine according to claim 3, wherein
the bearing comprises, on an end surface thereof, an annular recess that is depressed toward a bearing hole, the end surface being adjacent to the fluid element, and
the annular recess of the bearing forms a portion of the back space.

7. The rotating machine according to claim 1, further comprising
an electric motor that rotates the rotating shaft, wherein
the electric motor, the bearing, and the fluid element are arranged in this order in an axial direction of the rotating shaft.

8. The rotating machine according to claim 1, further comprising
an electric motor that rotates the rotating shaft, wherein
the discharge hole allows communication between a space in which the electric motor is housed and the hollow portion of the rotating shaft.

9. The rotating machine according to claim 7, further comprising
when the discharge hole is defined as a first discharge hole, a second discharge hole provided in the rotating shaft, wherein
the electric motor is positioned between the first discharge hole and the second discharge hole in the axial direction of the rotating shaft.

10. The rotating machine according to claim 9, wherein
the second discharge hole allows communication between a space in which the electric motor is housed and the hollow portion of the rotating shaft.

11. The rotating machine according to claim 1, further comprising
a core disposed in the hollow portion and having a smaller diameter than an inner diameter of the hollow portion.

12. The rotating machine according to claim 1, wherein
the fluid element is a turbine wheel.

13. The rotating machine according to claim 12, further comprising:
a turbine nozzle that directs the working fluid toward the turbine wheel; and
a gap that exists between the turbine nozzle and the turbine wheel, and that leads to the introduction hole.

14. A refrigeration device comprising the rotating machine according to claim 1.

15. The refrigeration device according to claim 14, wherein
a refrigerant is air.
